(19) United States
(12) Patent Application Publication
(10) Pub. No.: US 2011/0233918 A1
(43) Pub. Date: Sep. 29, 2011

(54) TIME INTEGRATED INTEGRAL IMAGE DEVICE

(75) Inventor: Axel Lundvall, Solna (SE)

(73) Assignee: ROLLING OPTICS AB, Stockholm (SE)

(21) Appl. No.: 13/129,591

(22) PCT Filed: Nov. 13, 2009
(86) PCT No.: PCT/EP09/65105

§ 371 Date: May 17, 2011

(30) Foreign Application Priority Data
Nov. 18, 2008 (SE) 0850082-9

(51) Int. Cl. B42D 15/00; G02B 27/12

(52) U.S. Cl. 283/70; 359/619

(57) ABSTRACT

An optical device (10) for providing a synthetic integral image comprises a polymer foil stack. A first interface (17) of the polymer foil stack comprises at least one image area (82). A second interface, at a distance from the first interface, has focusing elements in a two-dimensional focusing element array. Optically distinguishable image data bearer structure points (83) are distributed over image areas (82) with a density above a first threshold, and over a background area (84) outside the image areas (82) with a density below a, lower, second threshold. The image data bearer structure points (83) within the image areas (84) together cover a minor part of the total area of the image areas (84).

### TECHNICAL FIELD

The present invention relates in general to optical devices and in particular to optical devices creating integral images.

### BACKGROUND

Planar optical arrangements giving rise to a synthetic three-dimensional image or an image that changes its appearance at different angles have been used in many applications. Besides purely esthetical uses, such arrangements have been used e.g. as security labels on bank-notes or other valuable documents, identification documents etc. The eye-catching properties are difficult to resemble by alternative devices and since the technique of fabricating such synthetic image devices requires advanced technology, false labels are thereby not very easy to produce.

In the published international patent application WO 94/27254, a security device is disclosed. The security device comprises an array of microimages which, when viewed through a corresponding array of substantially spherical microlenses, generates a magnified image. This result is achieved according to the long known Moiré effect and was now applied to provide security labels with images having a three-dimensional appearance. The array may also be bonded to the array of microimages.

In the published US patent application US 2005/0180020, a micro-optic security and image presentation system is disclosed, being based on a similar basic idea. A film material utilizes a regular two-dimensional array of non-cylindrical lenses to enlarge micro-images or image data bearer structures of an image plane. By adapting the focal properties of the lenses, the distance between the lenses and the image plane, the diameter of the lenses, different magnifications, field of view, apparent depth etc. may be changed.

In the published US patent application US2003/0058472 a method for reproducing an integral, panoramographic or full spatial image is disclosed.

In the published international patent application WO 01/39138, methods and apparatus for authentication of documents are disclosed, using an intensity profile of Moiré patterns.

As mentioned, synthetic images of this kind may be utilized as security or authentication labels. The optical devices are relatively complex to manufacture in order to achieve images behaving in a three-dimensional manner. It is also possible to cover e.g. the data bearer interfaces in such a way that direct replicas are practically impossible to make. This type of objects is thus relatively good candidates for being used as authentication labels. However, some minor problems remain. One problem with prior art security labels of this kind is that it might be difficult for a layman to know how to distinguish a difference between a true synthetic image featuring three-dimensional behaviours and images of simpler types exhibiting features resembling some of the aspects of three-dimensionality.

### SUMMARY

An object of the present invention is to provide an optical device which in a simple way can provide an image of well-known properties and an authentication method based on such optical device. The above object is achieved by devices and methods according to the enclosed patent claims. In general words, in a first aspect, an optical device for providing a synthetic integral image comprises a polymer foil stack. The polymer foil stack comprises at least one polymer foil. A first interface of the polymer foil stack comprises at least one image area. A second interface of the polymer foil stack has focusing elements in a focusing element array. This focusing element array is a two-dimensional array. The second interface is provided at a distance from the first interface. The distance is close to a focal length of the focusing elements. Optically distinguishable image data bearer structure points are distributed over the at least one image area of the first interface with a density above a first threshold, and optically distinguishable image data bearer structure points are distributed in a background area outside the at least one image area on the first interface with a density below a second threshold, where the second threshold is smaller than the first threshold. The image data bearer structure points within the at least one image area together cover a minor part of the total area of the at least one image area.

In a second aspect, a method for authentication of an object having a polymer foil stack according to the first aspect provided at a surface of the object comprises pivoting of the polymer foil stack relative a viewer and observing any appearance of a synthetic integral image as sign of authenticity.

One advantage with the present invention is that the optical device, which is difficult to copy, exhibit easily distinguishable properties, which even a layman can determine. An authentication can thus be based on such an optical device by simple means not requiring any particular knowledge or equipment. Other advantages are further discussed in connection with different embodiments in the detailed description.

### BRIEF DESCRIPTION OF THE DRAWINGS

The invention, together with further objects and advantages thereof, may best be understood by making reference to the following description taken together with the accompanying drawings, in which:

FIGS. 1A-C are illustrations of different focusing elements;

FIG. 2 is a schematic cross-sectional illustration of an optical device for providing a synthetic integral image according to prior art;

FIG. 3 is an illustration of how the maximum angle of view is defined;

FIG. 4 is a schematic cross-sectional illustration of an embodiment of an optical device for providing a synthetic integral image according to the present invention;

FIG. 5A is a schematic top view of an object plane of an embodiment of an optical device according to the present invention;

FIG. 5B is a schematic top view of the embodiment of FIG. 5A, with border lines for an image area indicated;

FIG. 5C is a schematic illustration of how a part of an embodiment of an optical device for providing a synthetic integral image according to the present invention may look when pivoted;

FIG. 6A is a schematic top view of an object plane of another embodiment of an optical device according to the present invention;

FIG. 6B is a schematic top view of an object plane of another embodiment of an optical device according to the present invention having associated sets of image areas;

FIG. 6C is a schematic top view of an object plane of another embodiment of an optical device according to the present invention having a full scale image area;

FIG. 7 is a schematic top view of an object plane of yet another embodiment of an optical device according to the present invention;

FIG. 8 is a flow diagram of steps of an embodiment of a method according to the present invention;

FIG. 9A is a schematic illustration of an embodiment of a valuable object according to the present invention;

FIG. 9B is a schematic illustration of an embodiment of a valuable document according to the present invention; and

FIG. 9C is a schematic illustration of an embodiment of a package according to the present invention.

### DETAILED DESCRIPTION

Throughout the drawings, the same reference numbers are used for similar or corresponding elements.

The optical device according to the present invention operates according to principles known as the Moiré effect. In the present application, the Moiré effect provides a magnification of a pattern and at the same time gives a synthetic integral, typically three-dimensional, image. Such an integral image is a perfect candidate to be used as security label or simply for being eye-catching. The Moiré magnifying principle as such is well known from the literature, and overviews can be found e.g. in “The Moiré magnifier” by M.C. Nutley et. al., Pure Appl. Opt. 3, 1994, pp. 133-142 or in “Properties of moire magnifiers” by H. Kamal et al., Optical Engineering 37 (11), November 1998, pp. 3007-3014. Arrangements operating according to the Moiré effect generally require high precision regarding the relative positions of the lens array and the array of objects to be magnified.

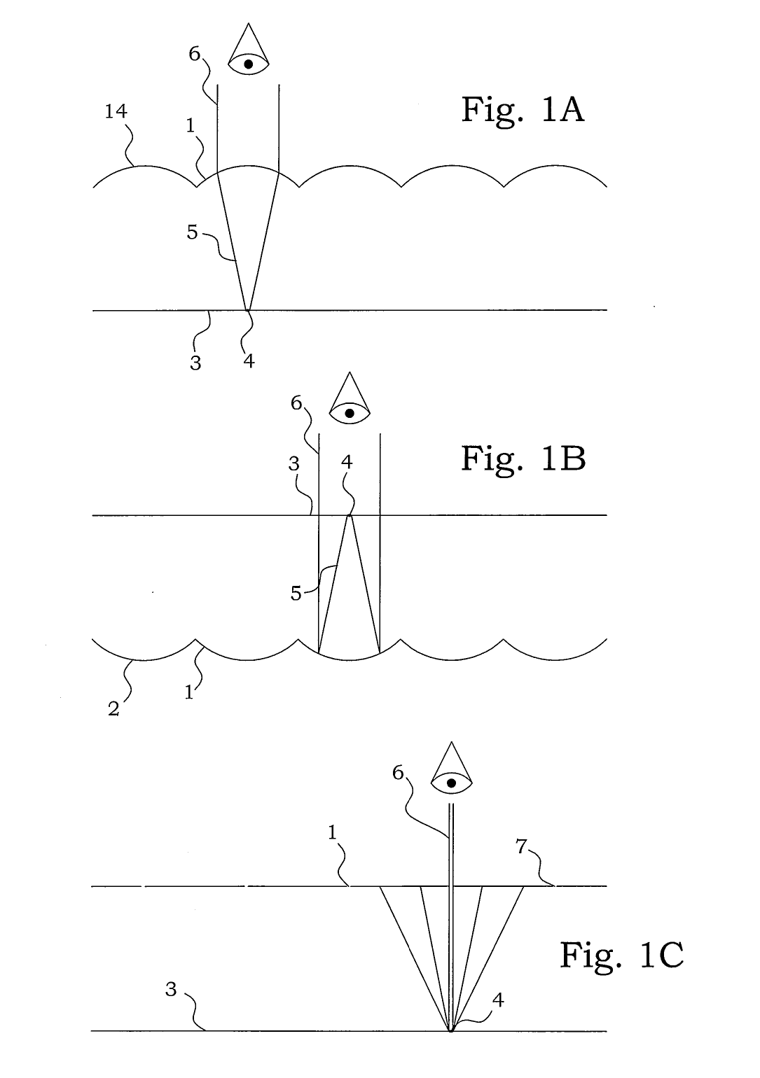

In the present disclosure, the term “focusing element” is used. Most devices based on the Moiré effect make use of different types of lenses or curved mirrors. However, this term is in the present disclosure intended to cover different types of equipment resulting in a selection of optical information from a small area. FIGS. 1A-C illustrate three examples of such focusing elements. In FIG. 1A, a focussing element 1, here in the form of a microlens 14, is provided at a distance from an object plane 3. Rays 5 from a small area 4 at the object plane 3 are refracted in the microlens 14, giving rise to a bunch of parallel rays 6 leaving the microlens 14. A viewer, looking at the microlens will only see the small area 4, enlarged to cover the entire area of the microlens 14.

In FIG. 1B, a focussing element 1, here in the form of a curved mirror 2, is provided at a distance from an essentially transparent object plane 3. Rays 5 from a small area 4 at the object plane 3 are reflected in the curved mirror 2, giving rise to a bunch of parallel rays 6 passing through the object plane 3. A viewer, looking at the object plane 3 will mainly see the small area 4, enlarged to cover the entire area of the curved mirror 2. The image of the small area is somewhat influenced by e.g. the small area 4 during the passage through the object plane 3.

In FIG. 1C, a focussing element 1, here in the form of an aperture 7, is provided above an object plane 3. A ray 6 from a small area 4 at the object plane 3 is the only ray that can pass the plane of the aperture 7 in a predetermined direction. A viewer, looking at the plane of the aperture can only see the small area 4, however, in this embodiment not enlarged.

In the rest of the present disclosure, microlenses will be used for illustrating focussing elements. However, corresponding ideas are also applicable to other types of focussing elements by making necessary changes in geometry and configuration.

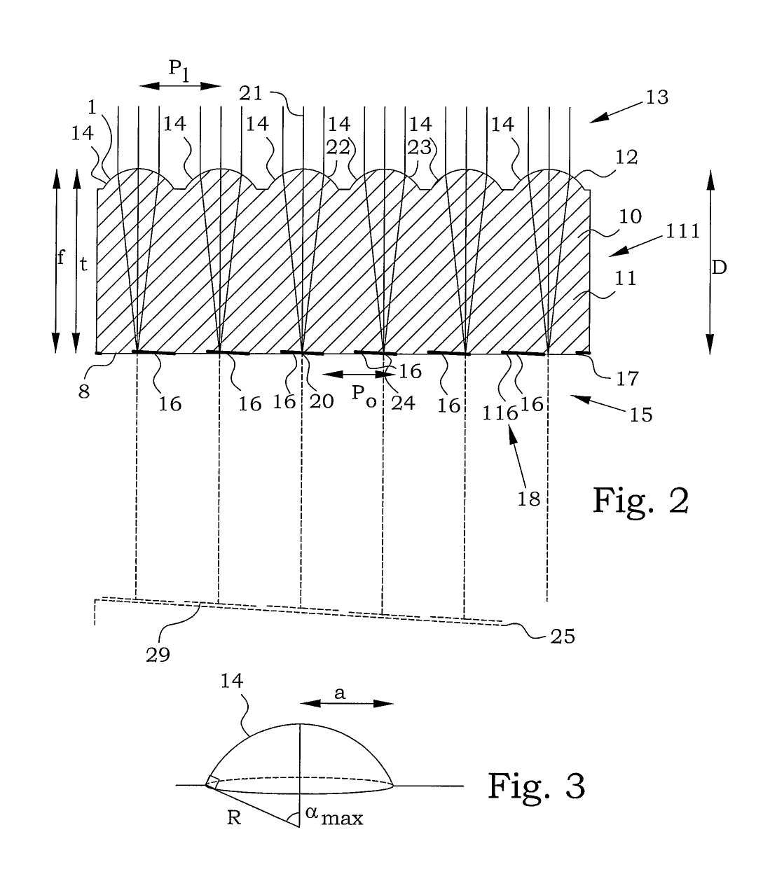

In order to understand the advantages of the present invention, a conventional optical device based on integration of magnified images of small image data bearer structures is first described. FIG. 2 illustrates schematically a cross-sectional view of an embodiment of an optical device 10 based on integration of magnified images of small image data bearer structures. The optical device 10 comprises a polymer foil stack 111, in this embodiment constituted by a single polymer foil 11 of thickness t. At an interface 12, in this case an outer surface of the polymer foil 11, a focusing element array 13 of focussing elements 1, in this case microlenses 14, are provided. The focusing element array 13 is typically a periodic two-dimensional array, which therefore is depicted as a one-dimensional array in the cross-sectional view of FIG. 1, with a periodicity Pₗ in the illustrated cross-section. The focusing element array 13 preferably covers essentially the entire interface 12.

The polymer foil 11 is also provided with another array, an object array 15, of identical geometrical structures 16. The geometrical structures 16 cause a difference in optical properties as seen from the microlens side. In the present embodiment, the geometrical structures 16 are provided at an interface 17 of the polymer foil 11, in the present embodiment another surface, opposite to the surface at which the microlenses 14 are provided. The interface 17 can thereby be seen as an object plane 3. The geometrical structures 16 in the present embodiment therefore become an interface 17 between the interior of the polymer foil 11 and the space 18 behind the polymer foil 11. The differences in optical properties of the polymer foil 11 and the space 18 makes it possible to distinguish the shape of the geometrical structures 16. The geometrical structures 16 thereby constitutes optically distinguishable image data bearer structures 116, which together, as viewed through the microlenses 14, compose an image. In a typical case, this image presents a three-dimensional impression. Other alternatives for image data bearer structures 116 could e.g. be structures of different colours, different reflectivity or absorption, which also gives rise to differences in optical properties.

The object array 15 is in the present embodiment also a periodic two-dimensional array and has furthermore the same symmetry properties as the focusing element array 13 of microlenses 14. A symmetry axis of the object array 15 of identical geometrical structures 16 is parallel to a symmetry axis of the focusing element array 13 of microlenses 14. In other words, the arrays 13, 15 are essentially aligned by their symmetry axes. If, for example, both arrays exhibit a hexagonal pattern, the close-packed directions are aligned. The object array 15 of identical geometrical structures 16 has a periodicity Pₒ, in the illustrated cross-section plane. The polymer foil 11 is essentially transparent or coloured transparent, at least between the pattern planes.

In order for the classical Moiré effect to be present, the periodicity Pₒ of the object array 15 of identical geometrical structures 16 differs by a non-integer factor from the periodicity Pₗ of the focusing element array 13 of microlenses 14. This relation determines the magnifying factor, as will be described more in detail below. Furthermore, the object array 15 of identical geometrical structures 16 has to be provided at a distance D from the first side 12 of the polymer foil 11 that is sufficiently close to a focal length f of the microlenses 14. In the present embodiment, having the geometrical structures 16 at the second side 17 of the polymer foil 11, puts a requirement on that the average thickness of the polymer foil 11 should be essentially equal to the focal length f. However, the distance between the arrays 13, 15 does not have to be exact equal to the focal length f.

The magnification of the image is dependent on the relative sizes of the periodicities Pₗ and Pₒ. In FIG. 2, the periodicity Pₒ of the object array of image data bearer structures 116 is slightly smaller than the periodicity Pₗ of the array of microlenses 14, i.e. Pₒ<Pₗ. A specific spot 20 at one of the geometrical structures 16 is in the illustrated embodiment situated exactly below, and furthermore in the focal point of, one microlens 22 of the microlenses 14. This means that light originating from the spot 20 ideally can travel through the polymer foil 11 and be refracted in the microlens above into a parallel beam of light rays 21. A spectator watching the first side 12 of the polymer foil 11 will experience the optical characteristics of the area around spot 20 spread out over the entire microlens 22, i.e. an enlarged part image 29 will be experienced. The microlens 23 will in the same manner provide another enlarged part image 29 of an area around spot 24 of another of the geometrical structures 16. Since there is a slight mismatch in periodicity, the area around spot 24 does not correspond exactly to the area around spot 20, but instead to an area slightly beside. By having a large number of microlenses 14 and geometrical structures 16, the areas that are imaged will ideally origin from every area of the geometrical structures 16. A spectator will thus experience a synthetic integral image 25 composed by the small part images 29 corresponding to a respective microlens 14. The part images 29 will together be experienced by the eye as a magnified synthetic three-dimensional integral image 25 of the geometrical structure 16.

From simple geometrical reasoning, it is found that the magnification becomes:

$$M = \frac{1}{F - {F}^{2}} , where F = \frac{{P}_{o}}{{P}_{l}} . \qquad ( 1 )$$

This relation is valid for parallel rays, i.e. when the foil is viewed from a distance that can be approximated by infinity. One may notice that the magnification becomes very large when the factor F comes close to unity. For a factor equal to unity, the magnification becomes infinite, which in traditional Moiré images is not very useful, since only one single spot at the geometric structures then will be visible. In order to get a useful image, it is thus traditionally necessary that the factor F differs from unity, and that the factor F differs from any integer value, i.e. F has to be a non-integer factor.

However, in order to achieve a large magnification, the factor should preferably be close to 1. In the embodiment of FIG. 1, the factor is smaller than 1, since Pₒ<P₁. The magnification thus has a positive value. If Pₒ>Pₗ, the factor is smaller than 1 and the magnification becomes negative, i.e. the image is reconstructed as an inverted image.

The design parameters of the polymer foil 11 have further impacts on the optical properties. Besides the property of magnifying the geometrical structures, the polymer foil 11 also provides a synthetic three-dimensional experience.

The focal distance of the microlens is given by:

$$f = \frac{{n}_{2} R}{( {n}_{2} - {n}_{1} )} , \qquad ( 2 )$$

where R is the microlens radius, n₂ is a refractory index for the microlenses and n₂ a refractory index for the medium covering the microlenses 14, i.e. typically air.

The field of view is mainly limited by the geometrical dimensions of the microlenses. FIG. 3 illustrates a microlens 14, having a base plane radius α. A maximum angle of view αₘₐₓ is then given by the maximum angle, at which the microlens surface can be reached at a perpendicular angle, i.e.:

$${α}_{max} = arcsin ( \frac{a}{{R}_{l}} ) . \qquad ( 8 )$$

When the maximum angle is exceeded, the image will rapidly deteriorate.

From the above description of a conventional prior art synthetic image optical device, it is easily under stood that each focusing element selects a tiny area at the object plane. For spherical mirrors and microlenses, this area is enlarged to cover the entire area of the spherical mirror or microlens. A viewer will thus experience a multitude of small images, corresponding to each focusing element. The human eye and brain is then arranged in such a way that the viewer experiences a large image, as composed by the spatially integrated small images. This is essentially the same process as composing a television image from the small individual spots of a television screen. The information from an optical device of this kind is, however, collected from a very small portion of the entire object plane.

If a small number of image points from the focusing elements are blocked, either by blocking the actual focusing element or by removing any structures from the tiny spot on which the focusing element focuses, a viewer will still be able to construct the integral image, however, with a worse clarity. The quality will decrease upon increased number of “blocked” focusing elements. If most of the image points are blocked, the human brain may have problems to construct the image at all. A corresponding effect occurs if structures are introduced where structures should not be present. A few such defects, will hardly be noticed, however, the more “defects” that are introduced, the more will the total image be deteriorated. If these aspects are combined, i.e. structures are removed from spots where structures are intended to be and structures are introduced where structures are not intended to be, the limit, where a total image is no longer perceivable, occurs earlier.

This effect can be utilized according to the present invention for authentication purposes. If such a deliberately deteriorated object plane is provided, it may be hard for a viewer to distinguish a pattern or image. However, besides the spatially integrating ability of the human viewing system, the brain also provides a certain time integration. The time resolution for the eye system of a human is about 20-25 Hz. Events occurring within shorter time period than about 40-50 ms will not be possible to distinguish. Normal lightening systems operate at frequencies of 50-60 Hz and the result is perceived by the human viewing system as a constant light source. One of the ideas of the present invention is therefore to utilize the time integrating ability of the human eye and brain to compose an image.

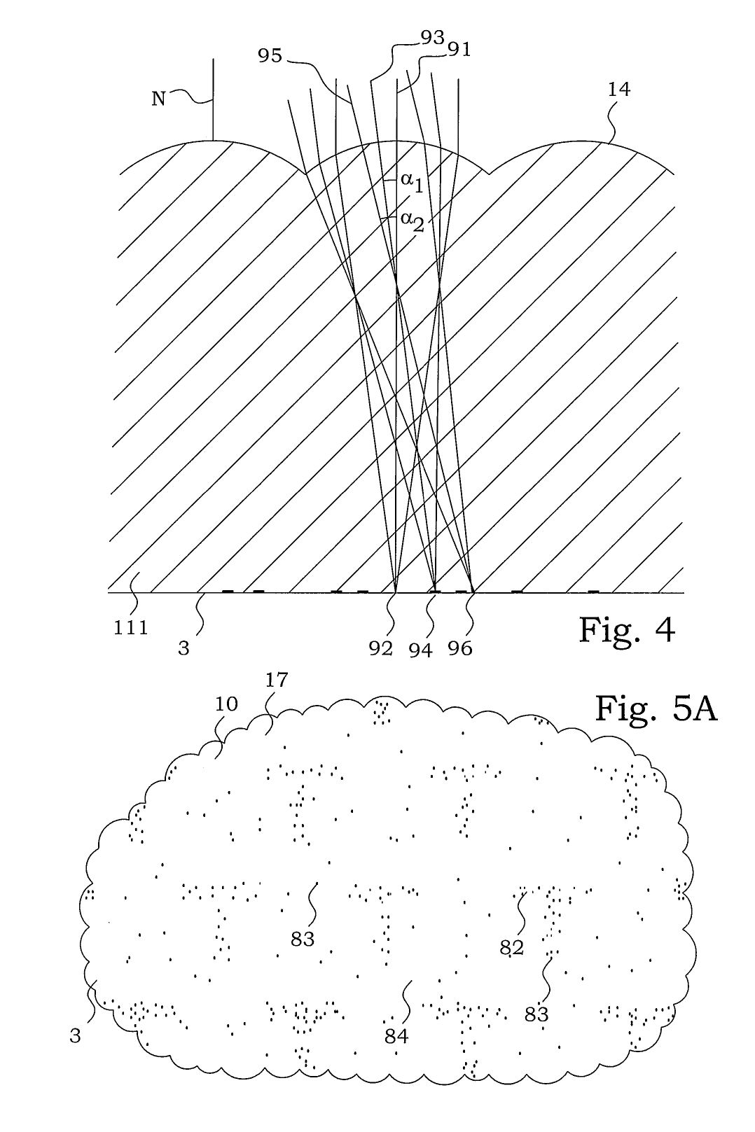

If the angle of view with respect of an optical device providing synthetic images according to the principles of e.g. FIG. 2 is changed, another area at the object plane is targeted. This means that if the optical device is tilted, the targeted area at the object plane will move accordingly. If such a change in viewing angle occurs fast enough, the human eye and brain will use their time integration abilities to integrate the impressions from each spot that the targeted area crosses within such an “integration” time constant. This is schematically illustrated in FIG. 4. Rays 91 parallel to a normal N to the polymer foil stack 111 origin from a small area 92 straight under the microlens 14, i.e. at the intersection of the optical axis of the microlens 14 and the object plane 3. In the present illustration, the area 92 is free from structures and therefore nothing is seen by the rays 91. However, rays 93 travelling with an angle α₁ compared to the normal N or optical axis origin from a small area 94 at the object plane 3. Here, a geometrical structure is present and this structure is thus enlarged by the microlens 14. Furthermore, rays 95 travelling with an angle α₂ compared to the normal N origin from a small area 96 at the object plane 3. In the present illustration, the area 96 is free from structures and therefore nothing is seen by the rays 95. By changing the angle of view sufficiently fast, the eye will notice the structure 94 and consider it being available for the entire “integration time” of the brain.

It is here also worth noting that the actual point within a total image, which is supplied by the microlens 14 will change upon changing the angle of view. However, by having a similar arrangement for all microlenses in a large focusing element array, the total effect as experienced by the viewer becomes the same. Occasionally, a structure is viewed corresponding to a certain position of the image, and a total image can be built if the angle of view is changed. For practical reasons, the change in angle of view is typically provided by tilting the polymer foil stack back and forth with respect to the eye of the viewer. However, also the opposite is possible, i.e. moving the viewers head with respect to the polymer foil stack.

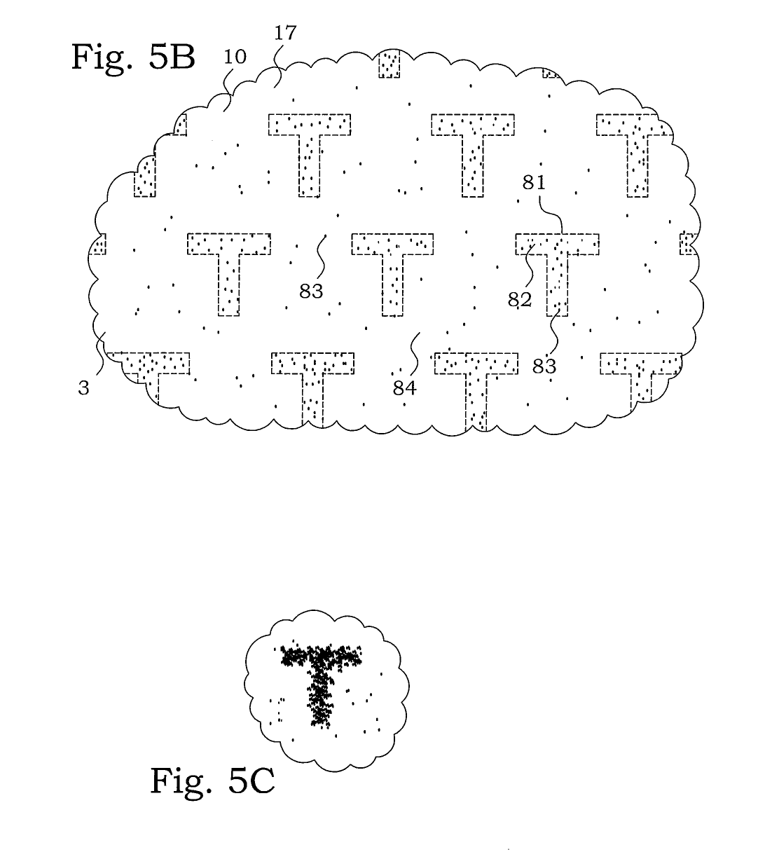

FIG. 5A illustrates schematically how an enlarged part of an object plane 3 may look like. The intended final image is in this embodiment a “T” as vaguely can be discerned. In FIG. 5B, a broken line 81 has been added to define the intended limits of the “T”. This line is of course not present at the real object plane 3 and is only for purpose of illustration in this figure. The broken line 81, however, defines an intended image area 82. This image area 82 is in the present embodiment, in analogy with a conventional moire foils, provided in a repetitive two-dimensional object array. However, in contrary to conventional films, not the entire image area 82 is covered with a structure. Instead, most of the points within the image area 82 are “empty”. However, optically distinguishable image data bearer structure points 83 are scattered over the image area 82. The image data bearer structure points 83 are distributed in different fashions over the different image areas 82, for instance in a random manner. The mean coverage of optically distinguishable image data bearer structure points 83 is thus considerably lower than the intended mean intensity of the object to be imaged. The density of the image data bearer structure points 83 within the image areas 82 is higher than a first, predetermined, threshold. However, the density of the image data bearer structure points 83 should be so low that the image data bearer structure points 83 within the image areas 82 together cover a minor part of the total area of the image areas. In other words, it should be difficult for an observer to create a perfectly defined image without using any time integration caused by pivoting the polymer film stack. In other words, the density of optically distinguishable image data bearer structure points 83 is thus so low than a trustful definition of the edge of the object 81 cannot be performed by the human eye. To this end, the image data bearer structure points within the image areas should together preferably cover less than 30% of the total area of said image areas. More preferably the image data bearer structure points within the image areas should together cover less than 10%, and more preferably less than 5% and most preferably less than 1% of the total area of said image areas. The image data bearer structure points 83 can also be randomly distributed over the image areas 82. However, other way of distributing the image data bearer structure points 83 are possible, e.g. according to different distribution algorithms.

In the present embodiment, where the image data bearer structure points 83 are distributed in a random manner, the density of the image data bearer structure points 83 should be high enough to ensure that essentially every point within the image areas 82 is covered by an image data bearer structure point 83 in at least one place at the entire polymer foil stack. If one instead uses any distribution algorithm, these algorithms can be constructed in such a way that it is ensured that every point within the image areas 82 is covered by an image data bearer structure point 83 in at least one place at the entire polymer foil stack. The total density of the image data bearer structure points 83 can in such a case probably be kept lower.

Another way to look at this feature is that the distribution of image data bearer structure point 83 is such that by a tilting speed compatible with manual operation, an angle range that is likely to include at least one image data bearer structure point 83 should be passed every 40-50 ms. The eye will thereby interpret the appearance of the focussing element to always having an image data bearer structure point 83 associated to it.

Around the image areas 82 is a background area 84. This background area 84 is intended not to give any total structure information. However, also over this area, optically distinguishable image data bearer structure points 83 are distributed. However, the density of the image data bearer structure points 83 is lower, below a second, predetermined, threshold. The second threshold should preferably be considerably smaller than the first threshold, in order to produce a significant difference in average occurrence of image data bearer 10 structure points 83. However, the mean coverage of optically distinguishable image data bearer structure points 83 in the background are is considerably higher than the intended mean intensity of the background area surrounding the actual object to be imaged. More preferably, the second threshold is less than 10% of the first threshold and most preferably less than 1% of the first threshold. The image data bearer structure points 83 can be randomly distributed also over the background areas 84.

In FIG. 5C, it is illustrated how an image may look like when the optical device is pivoted enough for passing a distance corresponding to 25-30 focus spots at the object plane 3. The contours of a “T” is now much clearer for a viewer. However, the image perceived in such a way gives no or at least a deteriorated depth impression.

Typically, the image data bearer structure points 83 are stamped into the interface of the object plane, which gives relief structures in the polymer foil. However, printed or lithographically defined image data bearer structure points 83 are also possible as well as image data bearer structure points 83 provided in other ways, as such known in prior art.

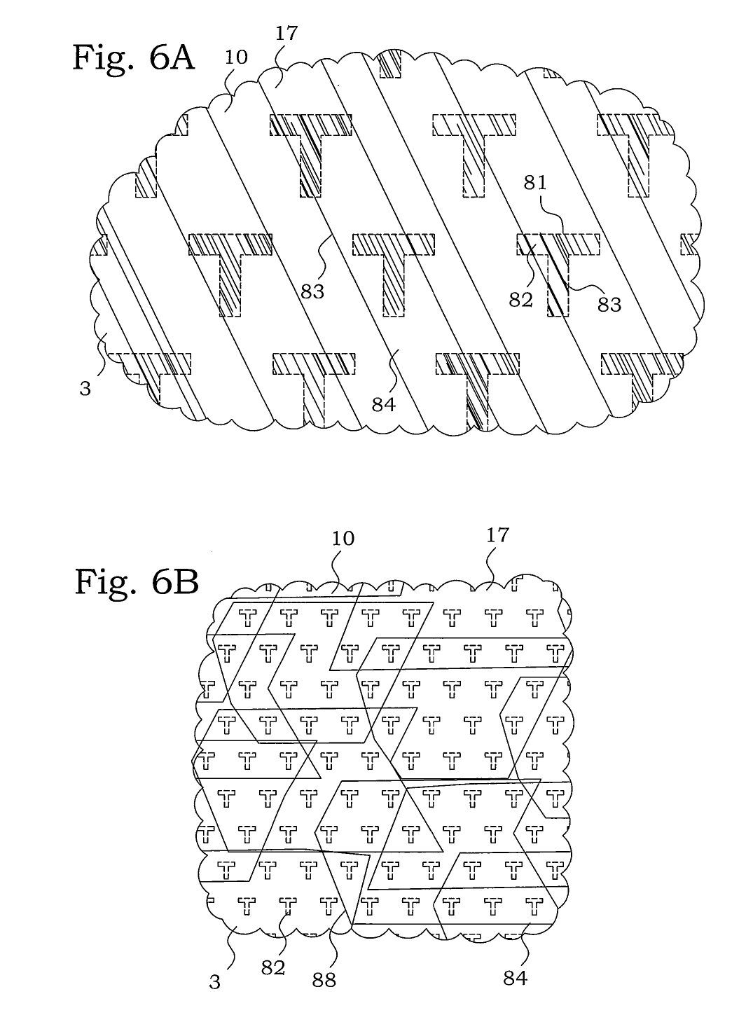

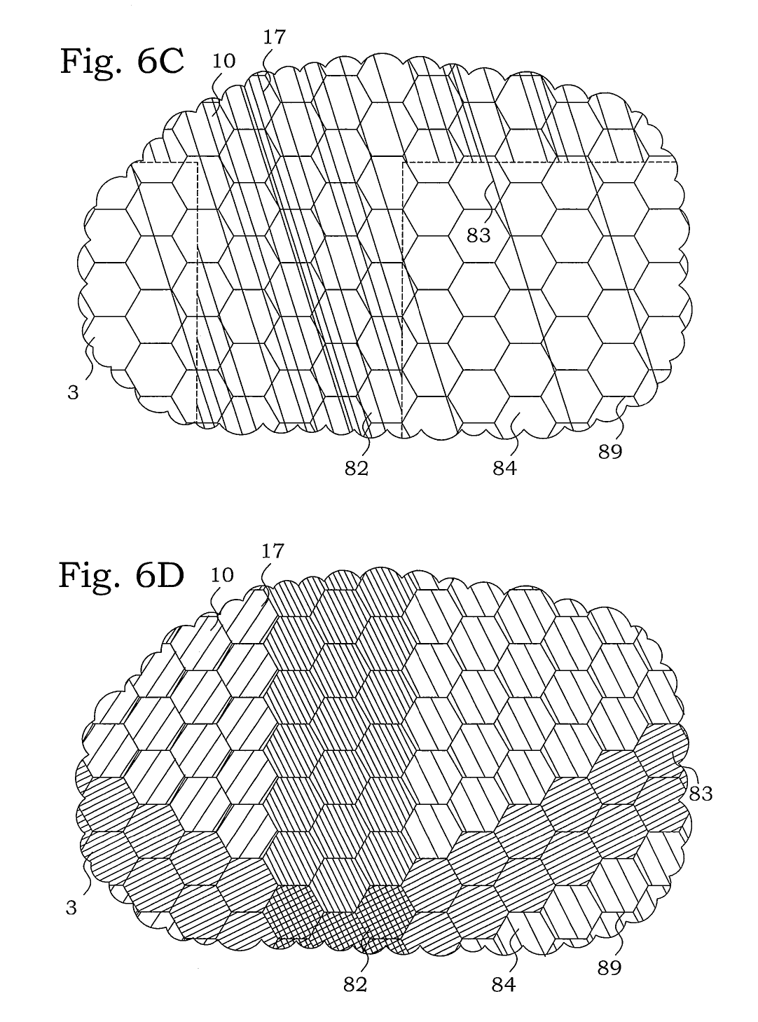

Even if the preferable way of distributing image data bearer structure points 83 is randomly, other ways can be used. FIG. 6A illustrates an embodiment, where the image data bearer structure points 83 are distributed in narrow parallel lines 85. The lines are, however, at random distances from each other. In such a case, a tilting along the lines will not cause any change in the perceived image, while a tilting across the lines will 30 assist in building up an integrated image. However, the depth feeling in such image is also poor.

FIG. 6B illustrates the object plane of another embodiment of an optical device according to the present invention. The magnification of the illustration is much smaller than for e.g. FIG. 6A. The individual image data bearer structure points are therefore too small to be illustrated. Here, sets 88 of image areas 82 are defined. Within each set 88 of image areas 82, all image areas 82 are provided with a certain predetermined pattern of image data bearer structure points. The sets 88 are preferably at least partially overlapping, which means that the image areas 82 are provided with image data bearer structure points associated with more than one set. This also means that even when two image areas 82 belongs to a same set, the individual patterns of image data bearer structure points may differ, if they also belongs to different other sets of image areas 82. This arrangement of sets means that going from one focusing element to a neighbouring one covering image areas 82 within a same set, there is a correlation between certain of the image data bearer structure points. This correlation gives rise to an improved three-dimensional impression compared to e.g. to the embodiment of FIG. 5A.

The size of the set 88 can be very different from case to case. If a strong three-dimensional impression is requested, the set area should preferably be relatively large, comprising e.g. hundreds of image areas 82 each. On the other hand, if a very low density of image data bearer structure points is used, the degree of time integration has to be very large, and the set area should be small, even down to just a few image areas. The size of the sets 88 may also be varied within one and the same polymer foil stack.

In the above embodiments, identical image areas 82 are provided in a two-dimensional, preferably periodic, array. However, the principles of integration upon tilting described above are also possible to achieve by more irregular image area arrays. The arrays can thereby e.g. be nonperiodic in at least one direction. Furthermore, the image areas 82 may even change along the array, e.g. when the intended image area is too large to be presented at an area corresponding to a single focusing element. In such a case, a part of a total image area can be presented at each array position at the object plane.

In FIG. 6C, an object plane of yet another embodiment of an optical device is illustrated. Here, the three-dimensionality is totally abandoned. One image area 82 is provided in the same size as the intended perceived image. The areas covered by the different focusing elements are indicated as hexagons 89. The image area 82 thus covers more than one focusing element. Each focusing element will in such an embodiment just indicate whether or not an image data bearer structure points 83 is present in that particular direction or not. The image data bearer structure points 83 can be provided as small “spots”, in analogy with FIG. 5A, or as in the present embodiment, aggregated into lines. This also gives the possibility to give different results of the pivoting in different directions. In directions crossing the lines, an image will be created. The quality will increase with the angle until the pivoting is made around an axis parallel to the lines. When the optical device is pivoted around an axis perpendicular to the lines, there will be no change in the appearance and no enhancement of the image will be provided. It would even be possible to place the lines at different angles at different part image areas, which can give rise to different images when pivoting the device in different directions.

These principles are further developed in the embodiment of FIG. 6D. Here, the different hexagons 89 are provided with different line patterns. One point at a time is imaged through the corresponding focusing element and is thereby shown for a viewer. Typically, the entire area of each focusing element is experienced as either light or dark. By pivoting the polymer foil stack, the imaged point is changed and the result is that the corresponding focusing element is twinkling when the imaged point passes the lines. This twinkling occurs with a frequency determined by the line pattern and the pivoting speed. When the twinkling exceeds 20-25 Hz, the element will be perceived as an element with a steady appearance. The line pattern has several parameters, which determined the twinkling properties; the density of lines or distance between lines, the line width, the line direction relative to the pivoting direction. Also the line “phase”, i.e. the position in relation to other areas, influences the nature of the twinkling. When a fast enough twinkling is reached, the time integrating function of the human eye results in that a steady image point is perceived. By adapting line 10 density, line direction and line phase, the nature of the twinkling and thereby the nature of the imaging properties can be controlled.

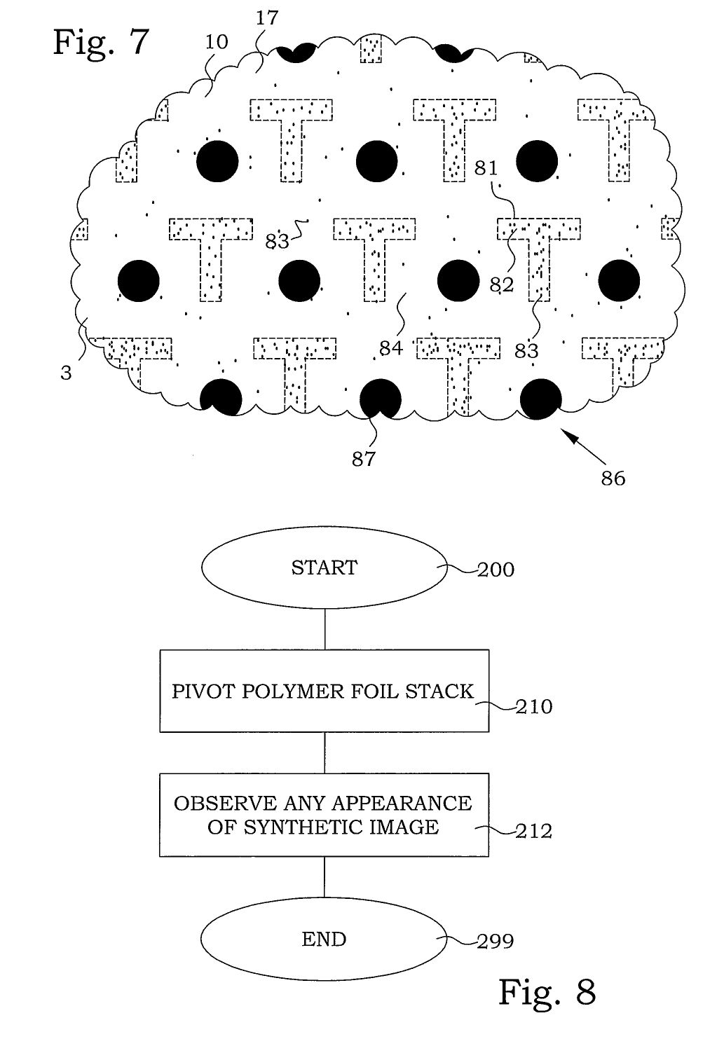

These pivoting or vibration enhanced images can of course be combined with ordinary Moiré images. FIG. 7 illustrates an embodiment, where an object array 86 of “full” data bearer structures 87 are provided superimposed on the object array of image areas 82 with image data bearer structure points 83. This full image object array 86 can be provided with a different periodicity compared with the image area 82 array and the corresponding image may thus appear with a different magnification and a different apparent depth than the pivoting or vibration enhanced images. The background area 84 corresponds in such an embodiment to the area outside both the image areas 82 and the data bearer structures 87. If such an optical device is kept still, only the full image is perceived. If a vibration or tilting motion is given, both images will be present simultaneously.

The differences in image appearance depending on the motion of the foil stack can advantageously be utilized for purposes of security labelling or authenticity proof. The properties of the appearance of the synthetic image upon tilting, according to the present invention are to our knowledge difficult to resemble in any other way, and the process of pivoting or vibrating is a concept that is easy to understand for any person. Thus, a security label that has to be vibrated in order to produce an image to verify is far more difficult to provide by other means than direct replicas, and is easily noticeable also for an inexperienced viewer.

In FIG. 8, a flow diagram of steps of an embodiment of a method according to the present invention is illustrated. A method for authentication of an object having a polymer foil stack provided at a surface of the object starts in step 200. The polymer foil stack is made according to the principles mentioned further above. In step 210, the polymer foil stack is pivoted relative a viewer. In step 212, any appearance of a first synthetic integral image is observed as a sign of authenticity. The method ends in step 299.

If the image foil comprises data structure points of more than one image, the pivoting can be performed in more than one direction, or by more than one pivoting speed, and thereby reveal further differences in the structures. Differences between the images can then be utilised as authentication means. In other words, the polymer foil stack is pivoted relative a viewer in another direction and/or at another pivoting speed, whereby the observation comprises observing of differences in appearance of synthetic time integrated integral images between pivoting in these different manners.

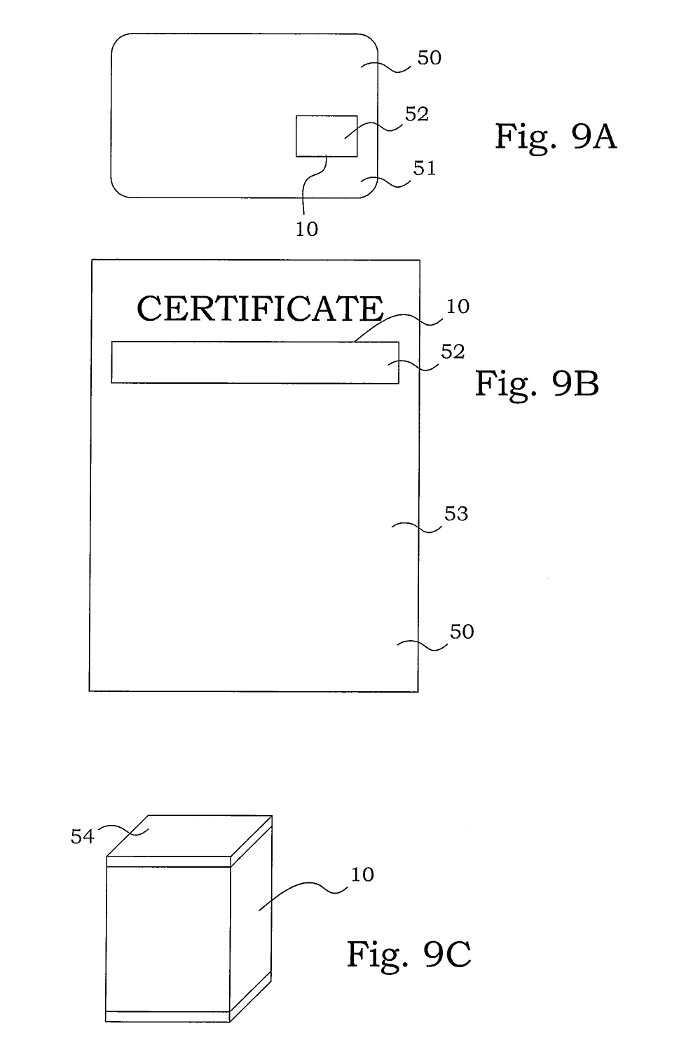

An optical device according to the present invention has many applications. By providing the geometrical structures inside the polymer foil, e.g. by covering the backside of an imprinted foil with an additional irremovable layer, as to form a monolithic foil, the possibilities to copy the optical device are practically entirely removed. This makes the optical device very interesting as a security label, as also discussed further above. In FIG. 9A, a valuable object 50, in this case a credit card 51, comprises a security label 52 comprising at least one optical device 10 according to the above description. In a typical case, the optical device 10 is adhered in some way to the valuable object 50. A characteristic image can easily be provided by pivoting the optical device 10 in order to certify that the valuable object 50 is a genuine one or to move the viewer's eyes relative to the object 50. The valuable object may not necessarily be an object directly connected to economical transactions. The valuable object may also e.g. be clothes, watches, electronics products etc. where counterfeiting is common.

Since the optical devices according to the present invention are believed to be of reasonable cost, a security label 52 comprising at least one optical device 10 according to the above description can even be of interest to certify the genuinety of documents 53, as illustrated in FIG. 9B. The document 53 may be valuable as such, e.g. a bank note or a guarantee commitment. However, the document 53 may not necessarily have any own value, but the security label 52 can be provided in order to guarantee that the information in the document is authentic.

Since the mass production costs of the optical device are expected to be small, the size of the security label does not necessarily have to be small. It is even feasible that the security may occupy a large part of a surface of an object in order to verify the authenticity. FIG. 9C illustrates a package 54 to a large extent consisting of a large area optical device 10 according to the present invention. Due to the specific properties of the optical devices according to the present invention, the optical device preferably has a static image overlaid on the pivoting enhanced image. If a non-transparent appearance is preferred, the optical device 10 is preferably adhered, e.g. by gluing, to some backing material, typically based on some paper product. Since the optical appearance of the optical device 10 may be designed to be attractive for a view to look at, the optical device 10 can have the combined functionality of ensuring authenticity as well as providing an eye-catching package material. It would e.g. be possible to authenticate e.g. a perfume by providing a package or even the perfume bottle itself by the optical device 10. In a practical case, one should be aware of that for utilizing the authenticity proofing abilities, the package should be small enough to be possible to pivot fast enough for achieving the pivoting enhanced features.

When using the optical device for eye catching purposes, larger devices can be used, and the change in viewing angle may instead be provided by moving the viewers head. A message, a brand or just a nice eye-catching pattern can e.g. be provided when a viewer moves along the optical device. In such a way, the present invention would even be possible to use e.g. for advertisements.

The applications of optical devices according to the present invention are enormous. Most applications are based on sheet materials, where the optical device can be provided as a part or the entire sheet material. The fields of application are very different, ranging from e.g. currencies, documents, financial instruments, product and brand protection, product marking and labelling, packaging, tickets, book covers, electronic equipment, clothes, footwear, bags to toys. The optical devices can be applied in any context where the appearance of a virtual three-dimensional image may be of benefit.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1.-14. (canceled)

15. Optical device for providing a synthetic integral image, comprising a polymer foil stack;
said polymer foil stack comprising at least one polymer foil;
a first interface of said polymer foil stack comprising at least one image area;
a second interface of said polymer foil stack having focusing elements in a focusing element array;
said focusing element array being a two-dimensional array;
said second interface being provided at a distance from said first interface;
said distance being close to a focal length of said focusing elements;
said at least one image area of said first interface comprising a plurality of first optically distinguishable image data bearer structure points;
said first optically distinguishable image data bearer structure points being distributed over said at least one image area of said first interface with a density above a first threshold;
a plurality of second optically distinguishable image data bearer structure points provided in a background area;
said background area being outside said at least one image area on said first interface;
said second optically distinguishable image data bearer structure points being distributed over said background area with a density below a second threshold;
said second threshold being smaller than said first threshold;
said plurality of first image data bearer structure points within said at least one image area together covering a minor part of the total area of said at least one image area.

16. Optical device according to claim 15, wherein said first interface of said polymer foil stack comprising several image areas in a two-dimensional object array.

17. Optical device according to claim 16, wherein identical said image areas are repeated in said object array and in that said focusing element array has a same symmetry as said object array.

18. Optical device according to claim 17, wherein said object array is periodic in two dimensions, said focusing element array is periodic in two dimensions, a symmetry axis of said focusing element array being essentially parallel to a symmetry axis of said object array, and in that a periodicity of said focusing element array differs from a periodicity of said object array by a non-integer factor.

19. Optical device according to claim 15, wherein said at least one image area is provided in the same size as the intended perceived image at said first interface.

20. Optical device according to claim 15, wherein said at least one image area is provided with said plurality of first image data bearer structure points in lines with predetermined line distances, line directions, line widths, line densities and line phases.

21. Optical device according to claim 15, wherein said plurality of first image data bearer structure points and said plurality of second image data bearer structure points are randomly distributed over said image areas and said background areas, respectively.

22. Optical device according to claim 15, wherein said plurality of first image data bearer structure points and said plurality of second image data bearer structure points are distributed over said image areas and said background areas, respectively, according to a distribution algorithm.

23. Optical device according to claim 15, wherein said plurality of first image data bearer structure points within said image areas together cover less than 30%, preferably less than 10%, more preferably less than 5% and most preferably less than 1% of the total area of said image areas.

24. Optical device according to claim 15, wherein said second threshold is considerably less than said first threshold, preferably less than 10% of said first threshold and most preferably less than 1% of said first threshold.

25. Optical device according to claim 15, wherein said first interface of said polymer foil stack further comprises a plurality of third optically distinguishable image data bearer structure points in a second object array;
said second object array being a periodic two-dimensional array of a same symmetry as said focusing element array;
a symmetry axis of said second object array being essentially parallel to a symmetry axis of said focusing element array; and
a periodicity of said second object array differs from a periodicity of said focusing element array by a non-integer factor.

26. Method for authentication of an object having a polymer foil stack provided at a surface of said object,
said method comprising the steps of:
pivoting said polymer foil stack relative a viewer in a first direction at a first pivoting speed, a first interface of said polymer foil stack comprising at least one image area, a second interface of said polymer foil stack having focusing elements in a focusing element array, said focusing element array being a two-dimensional array, said second interface being provided at a distance from said first interface, said distance being close to a focal length of said focusing elements, a plurality of first optically distinguishable image data bearer structure points are distributed over said at least one image area of said first interface with a first average density, a plurality of second optically distinguishable image data bearer structure points are distributed in a background area, said background area being outside said at least one image area on said first interface, said plurality of second optically distinguishable image data bearer structure points are distributed with a second average density, said second average density being considerably smaller than said first average density, said plurality of first image data bearer structure points within said at least one image area together covering a minor part of the total area of said at least one image area; and
observing any appearance of a synthetic time integrated integral image as sign of authenticity.

27. Method according to claim 26, further comprising pivoting said polymer foil stack relative a viewer in a second direction, different from said first direction;
wherein said step of observing comprises observing differences in appearance of synthetic time integrated integral images between pivoting in said first and second directions, respectively, as sign of authenticity.

28. Method according to claim 26, further comprising pivoting said polymer foil stack relative a viewer at a second pivoting speed, different from said first pivoting speed;
wherein said step of observing comprises observing differences in appearance of synthetic time integrated integral images between pivoting at said first and second pivoting speeds, respectively, as sign of authenticity.
